(19) United States
(12) Patent Application Publication
(10) Pub. No.: US 2009/0250470 A1
(43) Pub. Date: Oct. 8, 2009

(54) Tool Bucket

(76) Inventors: Bryce Merrick, Bruneau, ID (US); Elaine Merrick, Bruneau, ID (US)

Correspondence Address: GERARD CARLSON, 4503 S. RIVA RIDGE WAY, BOISE, ID, 83709, US

(21) Appl. No.: 12/418,594

(22) Filed: Apr. 5, 2009

Related U.S. Application Data
(60) Provisional application No. 61/042,596, filed on Apr. 4, 2008.

(51) Int. Cl. B65D 25/16; B25H 3/00; B65D 25/28

(52) U.S. Cl. 220/495.06; 206/349; 220/752; 224/235

(57) ABSTRACT

A tool bucket formed from a sleeve of material has a closed bottom and a mouth. A lip located around the sleeve between the bottom and mouth divides the sleeve into a liner between the lip and the mouth and a bucket between the lip and the bottom. The liner can be pulled out of the bucket to increase the capacity of the bucket or pushed into the bucket when not in use. A closure at the mouth prevents the loss of the contents of the bucket when the bucket is tipped.

### CROSS REFERENCE TO RELATED APPLICATIONS

This application claims the benefit of the provisional application entitled “Tool Bucket” by Bryce Merrick and Elaine Merrick, Ser. No. 61/042,596 filed Apr. 4, 2008, and is hereby incorporated by reference in its entirety.

### FEDERALLY SPONSORED RESEARCH OR DEVELOPMENT

Not applicable.

### JOINT RESEARCH AGREEMENT

Not applicable

### SEQUENCE LISTING

Not applicable

### FIELD OF THE INVENTION

The present invention relates to the field of tote bags and buckets, and in particular to reusable bags and buckets for transporting tools and equipment at construction sites, work sites and towers.

### BACKGROUND OF THE INVENTION

Currently the tool buckets used by workers on power poles or wind turbine towers have a closed bottom and an open mouth. When hoisting a tool bucket up a tower, the bucket can tip. The contents of a tipped bucket can fall great distances damaging the contents and endangering workers below.

In some cases, long tools like wrenches do not fit entirely in the bucket and make the bucket top heavy. This imbalance increases the likelihood of a bucket tipping and spilling the contents.

### SUMMARY OF THE INVENTION

In one embodiment, a tool bucket has a sleeve having a top and a closed bottom. A lip between the bottom and the top defines a liner portion from the lip to the top and a bucket portion from the lip to the bottom. The top defines a liner mouth. The lip defines a bucket mouth. In some applications the liner portion extends from the lip, away from the bottom to increase the effective height of the bucket. In other applications, the liner is tucked into the inside of the bucket, toward the bottom reducing the effective height of the bucket.

In another embodiment the liner mouth has a closure to constrain the contents of the bucket from falling out in the case that the bucket is tipped.

In other embodiments the lip is formed around a lip form that gives a shape to the bucket mouth and holds the mouth open for access to the contents of the bucket.

In further embodiments attachment points located between the lip and the bottom provide points to attach one or more bucket handles or hoisting harnesses.

In yet further embodiments, a boot at the bottom provides reinforcement and protection for the bottom. The boot acts to protect the bottom when the bucket is set on rough or sharp surfaces. The boot can also extend up the outside of the bucket to further protect the bucket.

In yet another embodiment a base at the bottom defines the shape of the bottom. A sole provides protection for the outside of the bottom, while a floor protects the inside of the bottom from sharp or abrasive contents.

### BRIEF DESCRIPTION OF DRAWINGS

The summary above, and the following detailed description will be better understood in view of the enclosed drawings which depict details of preferred embodiments. Like reference numbers designate like elements. It should however be noted that the invention is not limited to the precise arrangement shown in the drawings. The features, functions and advantages can be achieved independently in various embodiments of the claimed invention or may be combined in yet other embodiments.

FIG. 1 shows one embodiment of the tool bucket with the liner tucked into the bucket.

FIG. 2 shows one embodiment of the tool bucket with the liner extending out of the bucket.

FIG. 3 shows one embodiment of the tool bucket with the liner mouth folded closed.

FIG. 4 shows one embodiment of the tool bucket with the liner mouth folded closed and secured with the closure.

FIG. 5 shows an exploded view of one embodiment of the tool bucket.

FIG. 6 shows a top view of one embodiment of the tool bucket.

FIG. 7 shows a sectional view of the tool bucket depicted in FIG. 6.

FIG. 8 shows a one embodiment of the tool bucket with the closure constraining a load which extends out of the bucket.

FIG. 9 shows one embodiment of the tool bucket with the liner extended out of the bucket and the bucket collapsed.

FIG. 10 shows a short embodiment of the tool bucket.

FIG. 11 shows a tall embodiment of the tool bucket.

FIG. 12 is a flow chart showing exemplary use of the tool bucket.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that modification to the various disclosed embodiments may be made and other embodiments may be utilized, without departing from the spirit and scope of the present invention. The following detailed description is therefore, not to be taken in a limiting sense.

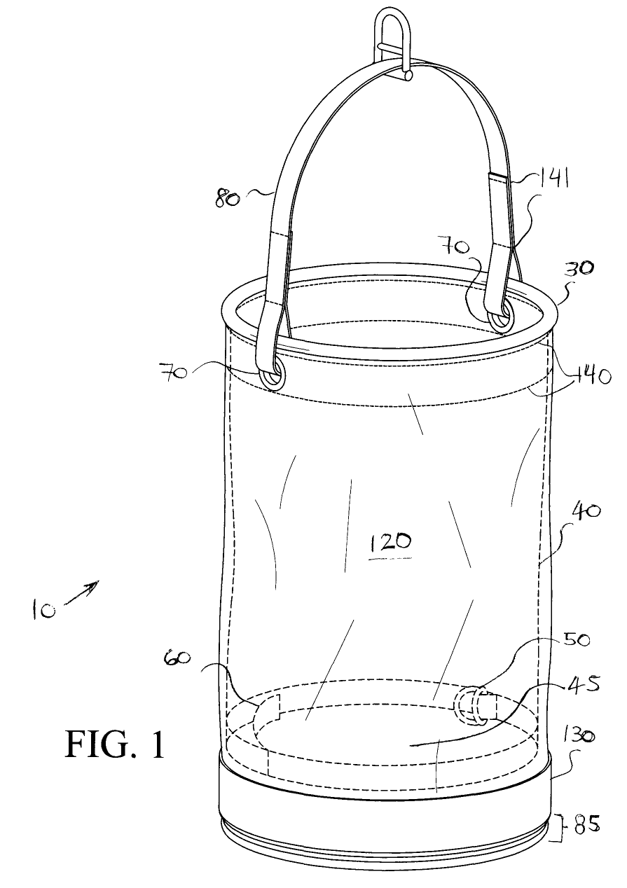

FIG. 1 shows one embodiment of a tool bucket 10. The tool bucket 10 is made of a sleeve 120. The sleeve 120 is folded in on itself at a lip 30. That portion of the sleeve 120 which is tucked inside of tool bucket 10 is depicted by hidden lines. The lip 30 divides the sleeve 120 into a liner 40 with an open liner mouth 45 both shown by hidden lines. Stitches 140 secure the lip 30. A closure of a double “D” ring 50 and a strap 60 are attached to the liner 40 near the liner mouth 45. The outer portion of the tool bucket 10 rests on a foot 85 which closes the bottom of the sleeve 120. A boot 130 protects and reinforces the lower portion of the bucket 10. Near the lip 30, attachment points 70 provides locations for the attachment of a handle 80. Stitches 141 secure the handle 80 to the tool bucket 10.

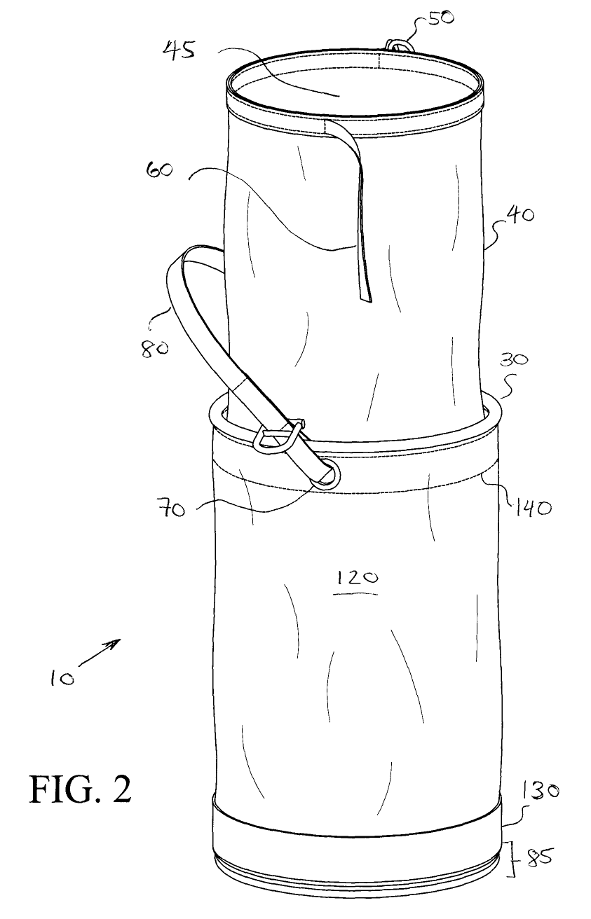

FIG. 2 shows the tool bucket 10 of FIG. 1 with the liner 40 extended away from the lip 30, foot 85, and boot 130. Note that by extending the liner 40, the effective height of the tool bucket 10 is increased. This allows the tool bucket 10 to adapt to a variety of contents of various sizes. The handle 80 is short in FIG. 2 for the sake of clarity, but could easily be longer to extend above the liner mouth 45. In this embodiment, the sleeve 120 is one continuous piece of material folded to form a lip 30 and stitched beneath the lip 30 with stitches 140. Beneath the lip 30 attachment points 70 provide locations for the attachment of handle 80. The upper portion of the liner 40 terminates at a liner mouth 45. The closure of a double “D” ring 50 (partially hidden) and a strap 60 is attached near the liner mouth 45. The liner mouth 45 opens to receive tools and supplies for transport.

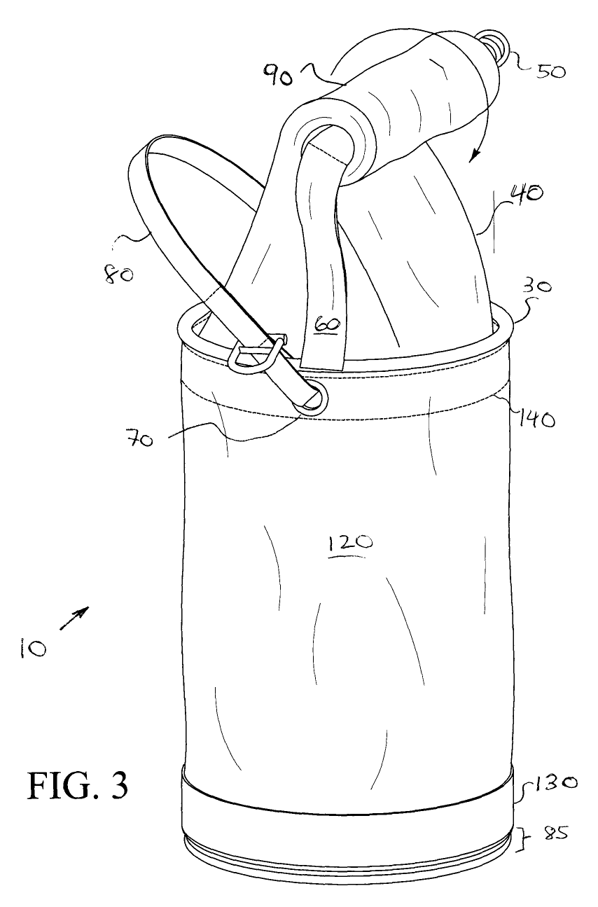

FIG. 3 shows the tool bucket 10 of FIGS. 1 and 2. The liner mouth 45 (FIG. 2) of the liner 40 is closed and flattened by pulling on opposite sides. The liner mouth 45 (FIG. 2) is then rolled or folded upon itself one or more times to form liner folds 90. The closure of double “D” ring 50 and strap 60 protrude from opposite sides of the liner folds 90. The liner folds 90 effectively close the liner 40. The number of liner folds 90 can be increased to lower the height of the liner 40 above the tool bucket 10, or decreased to increase the capacity of the tool bucket 10. In this manner, the tool bucket 10 can be expanded or contracted to accommodate various quantities of contents. This can be especially useful when carrying long tools such as wrenches.

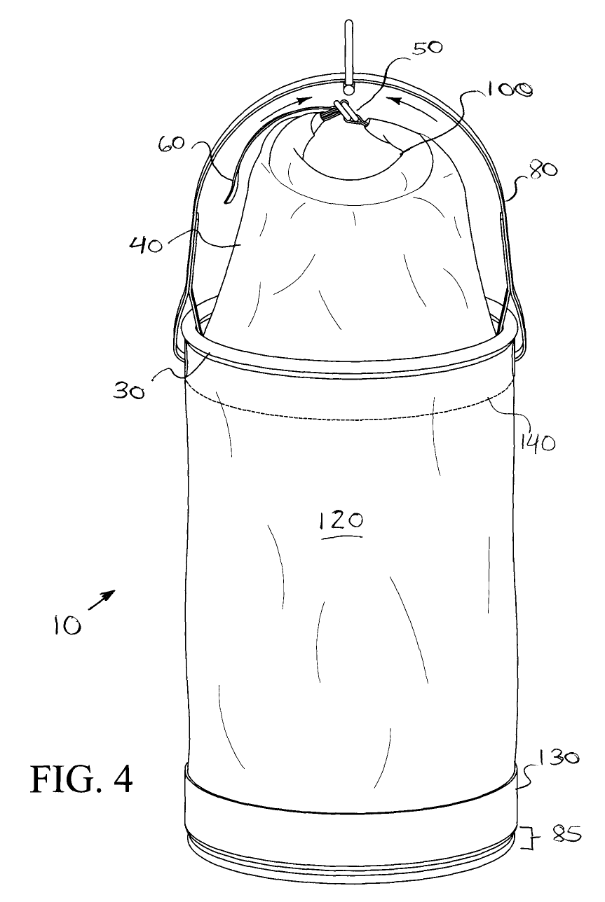

In FIG. 4 shows the tool bucket 10 of FIG. 3 with a closed liner 100. The double “D” ring 50 and strap 60 of the closure are attached together preventing the opening of the liner mouth 45 (FIG. 2). This closed liner 100, together with the liner folds 90 of FIG. 3 prevent the contents of the tool bucket 10 from falling out even when the tool bucket 10 is tipped. The handle 80, elevated above the closed liner 100, is available for hand carrying or hoisting.

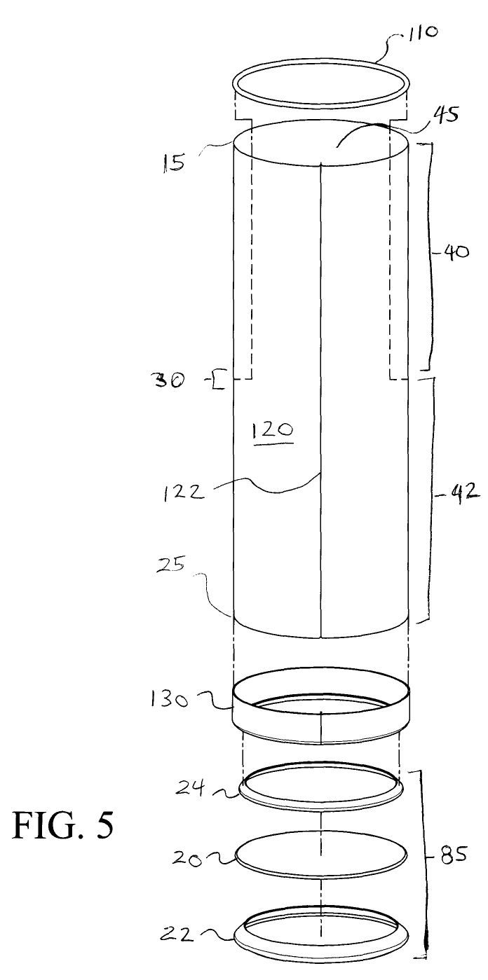

FIG. 5 shows the basic construction of one embodiment of the tool bucket 10 depicted in FIGS. 1-4. The sleeve 120 is made of a piece of rectangular material. Two opposite sides of the material meet at a seam 122 so that the sleeve 120 is generally tubular in shape. A lip form 110 is placed inside the sleeve 120 about one third to one half way down. The lip 30 of FIGS. 1-4 is formed when the sleeve 120 is folded over the lip form 110 and secured by the stitches 140 in FIGS. 1-4. The region from the top 15 of the sleeve 120 to the lip 30 defines the liner 40. The region from the lip 30 to the bottom 25 of the sleeve 120 defines the bucket 42. A boot 130 is applied to bottom 25 of the sleeve 120 and extends partially up the bucket 42. The boot 130 acts to protect the lower area of the bucket 42. The bottom 25 of the sleeve 120 is closed by a foot 85. The foot 85 has a sole 22, a base 20 and a floor 24.

The materials used to construct of tool bucket 10 of FIGS. 1-4 and shown in FIG. 5 can vary. In a preferred embodiment the sleeve 120 is canvas. However, the material of sleeve 120 may be a large variety of materials or combination of materials. Examples of sleeve material include, but are not limited to, canvas, rip stop nylon, fiber glass, or plastic films. Note that the sleeve material can be a woven fabric of natural or man-made fibers. The sleeve material can also be a plastic film. Composite materials are also possible. Examples include carbon or glass fibers alone or in combination with polyethylene or other plastics. Materials can be chosen for resistance to heat, chemicals stress or abrasion. Combinations of materials can provide several desirable characteristics in one application.

While a double “D” ring and strap are the liner closure method in a preferred embodiment, other embodiments are possible. Alternative closure methods include, but are not limited to draw strings, zippers, buttons, latches, hook and latch fasteners, and elastic. Furthermore, the strap can be of a number of materials including nylon, canvas, hemp, and polypropylene.

The foot 85 depicted in FIGS. 1-5 has a sole 22, a base 20 and a floor 24. The material choice for the foot components is chosen for the tasks and environment in which the tool bucket 10 will be used. For example, in a preferred embodiment, the sole 22 (FIG. 5) is leather. Other materials are possible including, but not limited to, plastic sheet, molded plastics, canvas, carbon or glass fibers, metal and composites. If a preferred embodiment, the base 20 is a medium density fiber wood product, also known as MDF. The base adds shape, strength and rigidity to the foot 85. Other possible materials for the base 20 include molded plastic, plastic sheet, metal, canvas and cushioning foams. The floor 24 makes contact with the contents of the tool bucket 10. In a preferred embodiment the floor 24 is canvas. In other embodiments the floor material can include plastic sheet, molded plastics, canvas, carbon or glass fibers, metal, cushioning foam and composites.

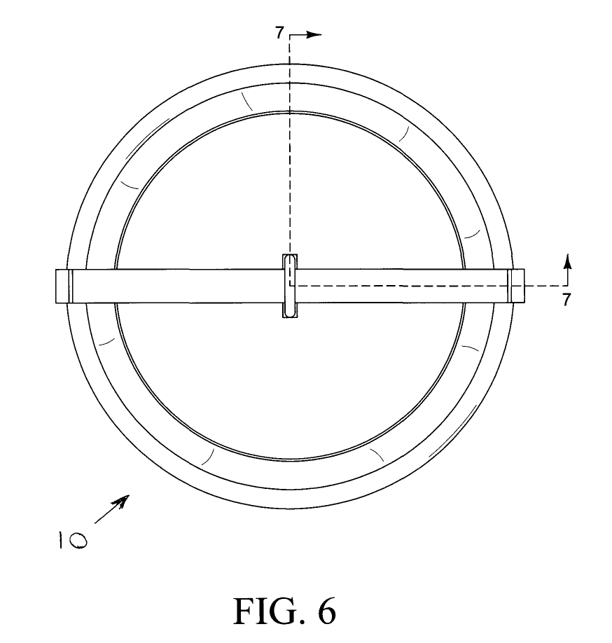

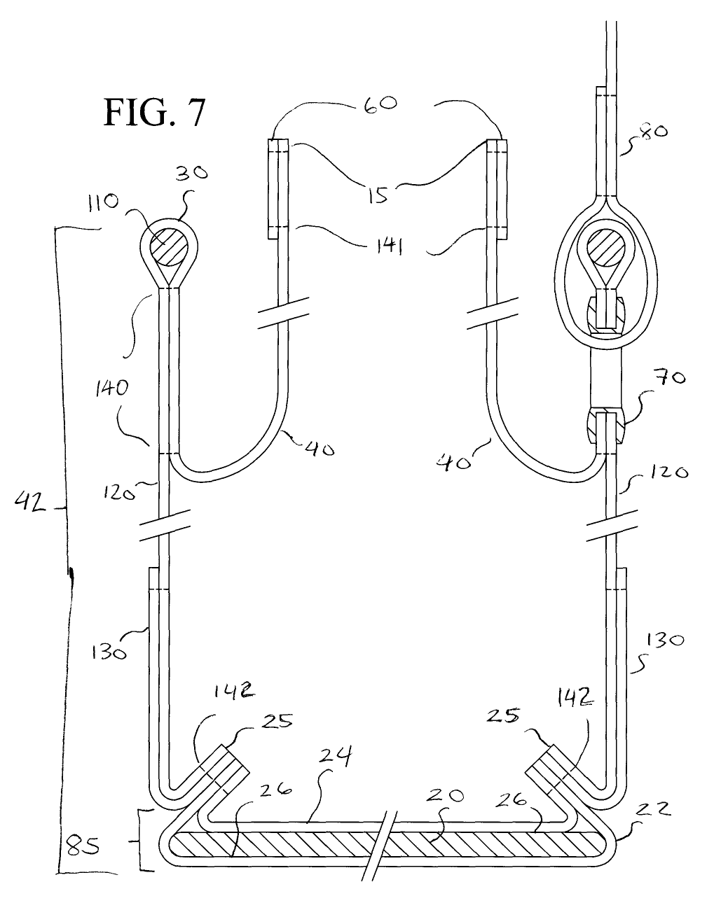

FIG. 6 shows a top view of one embodiment of tool bucket 10 and indicates a sectional view discussed in connection with FIG. 7

FIG. 7 shows a section of the tool bucket 10 of FIG. 6. The sleeve 120 is folded over a lip form 110 to form a lip 30. Stitches 140 in the sleeve 120 hold the lip form 110 in place. Attachment points 70 (of which one is shown) located below the lip form 110 provide a location for the attachment of a handle 80. The portion of the sleeve 120 that extends from the lip 30 to the top 15 of the sleeve 120 is the liner 40. The closure, in this example is a strap 60 attached to the liner 40 by stitches 141. Other closure attachment methods such as rivets, adhesives, and heat welding are also possible depending upon materials and preferences. The portion of the sleeve 120 from the lip 30 to the foot 85 defines the bucket 42.

The foot 85 in FIG. 7 has three layers, a sole 22, a base 20, and a floor 24. In this embodiment they are shown assembled with adhesive 26. Other attachment methods are possible including rivets, stitches, and heat welding. The foot 85 is assembled to the bottom 25 of the sleeve 120 by stitches 142. Included in the assembly is the lower portion of the boot 130. In other embodiments the foot 85 might be simplified by eliminating the sole 22, base 20 and floor 24 and gathering the bottom 25 of the sleeve 120. In such a case, the material of the sleeve 120 forms the floor of the bucket 42.

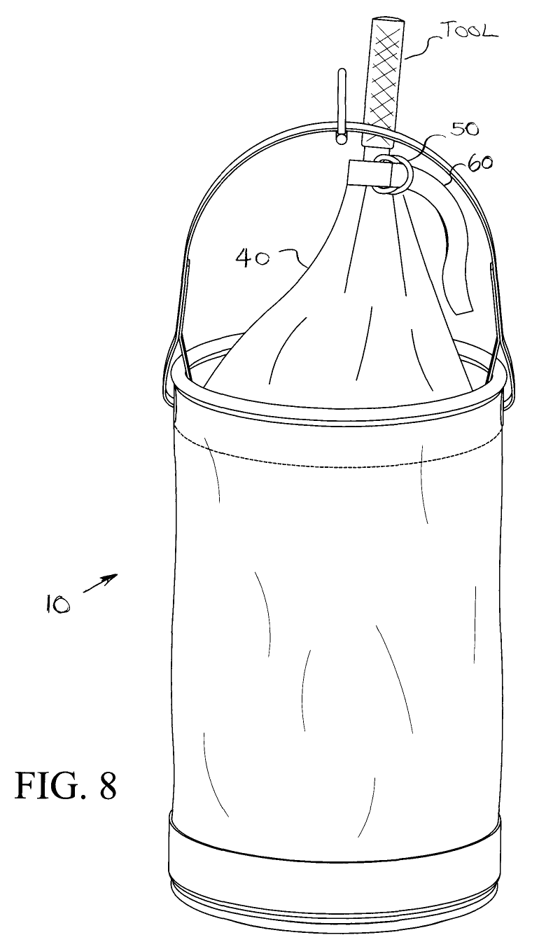

FIG. 8 shows yet another use of the tool bucket 10. FIG. 1 showed the tool bucket 10 as an open bucket with the liner 40 tucked inside. FIG. 2 showed the tool bucket 10 with the liner 40 extended to effectively increase the size of the tool bucket 10. FIG. 3 showed how the height of the tool bucket 10 can be adjusted to suit the application. FIG. 4 how the tool bucket 10 can be closed to prevent loss of cargo in the case of the tool bucket 10 tipping. In FIG. 8 a tool extends beyond the height of the extended liner 40. The tool is constrained by the closure of double “D” ring 50 and strap 60. This is particularly useful when there is a danger of the tool bucket 10 tipping and losing the cargo.

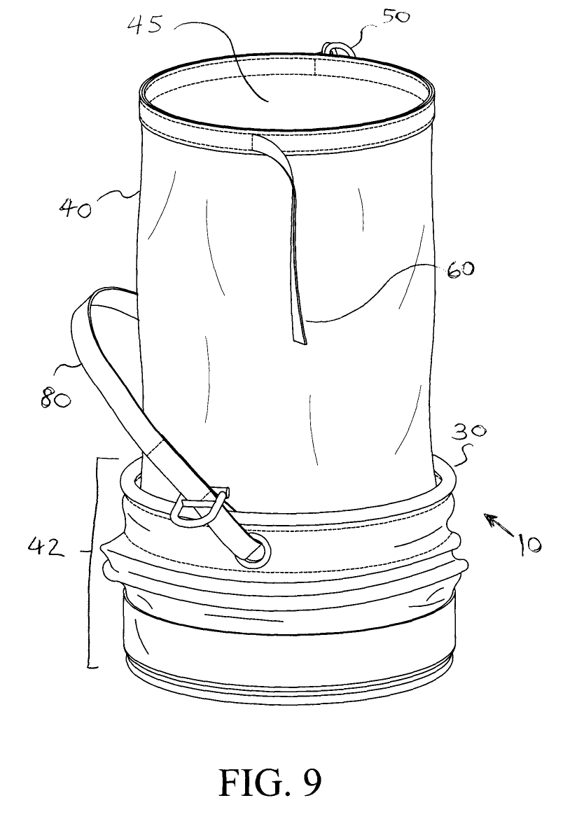

FIG. 9 shows another feature of too bucket 10. Liner 40, when tucked inside of the bucket portion 42 adds stiffness to the bucket. When the liner 40 is extended out from the lip 30 the bucket portion can be more easily collapsed as shown. Once the bucket portion 42 is collapsed, the liner 40, double “D” ring 50, strap 60, and handle 80 can be pushed into the bucket portion 42 past the lip 30. The resulting assembly is more compact and well suited for storage or transport.

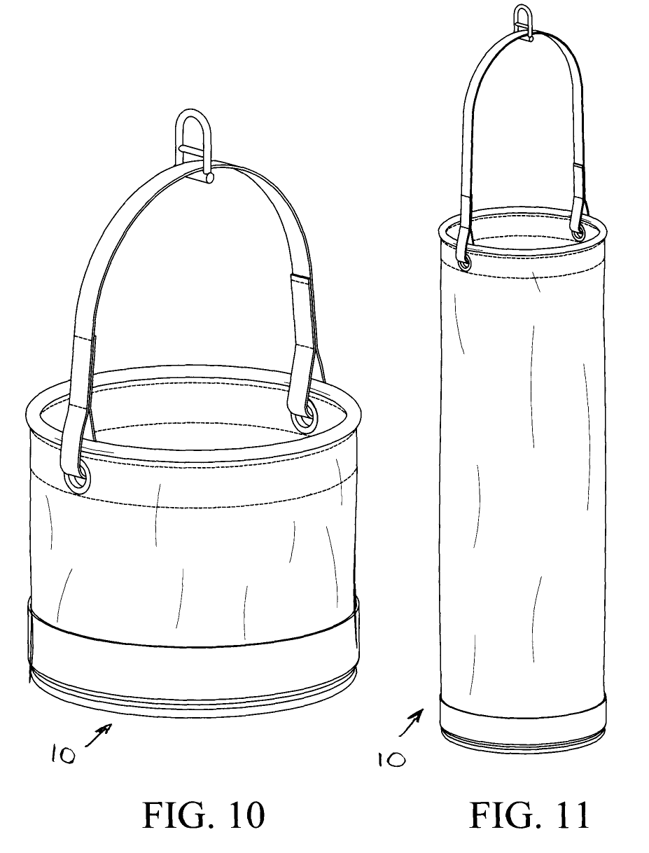

FIGS. 10 and 11 depict the tool bucket 10 in different sizes. Depending upon the application, the embodiments presented in previous figures are adaptable to a wide variety of size and aspect ratios.

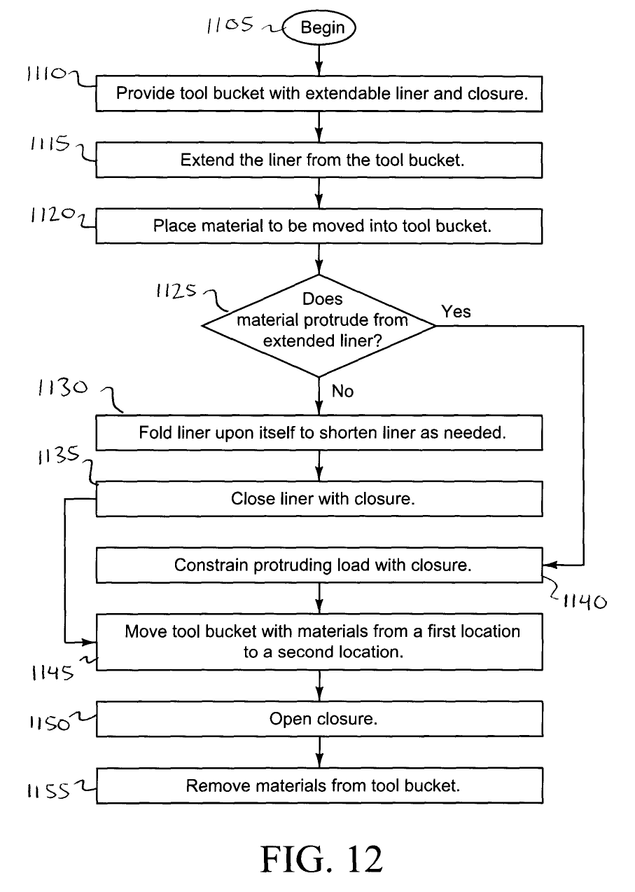

FIG. 12 is a flow chart of a typical application of the tool bucket. A user begins the process at 1105. At 1110 the user provides the tool bucket with the extendable liner and closure. At 1115 the user extends the liner from the tool bucket. At 1120 the user places the material to be moved into the tool bucket. At 1125 the user decides whether the loaded material protrudes from the extended liner. If it does protrude, the user constrains the protruding load at 1140 with the closure. If the load does not protrude, at 1130, the user folds the liner upon itself to shorten the liner as needed. The user then closes the folded liner at 1135. In either case, at 1145, the user moves the tool bucket with the materials from a first location to a second location. When the second location is reached, the user opens the closure at 1150 and removes the materials from the tool bucket at 1155.

Although this invention has been described in terms of certain preferred embodiments, other embodiments that are apparent to those of ordinary skill in the art, including embodiments that do not provide all of the features and advantages set forth herein, are also within the scope of this invention. Rather, the scope of the present invention is defined only by reference to the appended claims and equivalents thereof.

What is claimed is:

1. A tool bucket comprising:
a sleeve having a top, and a bottom, the bottom being closed;
a lip in the sleeve between the top and the bottom;
the portion of the sleeve between the lip and the top defining a liner; the portion of the sleeve between lip and the bottom defining a bucket; and
the top of the sleeve defining a liner mouth.

2. The tool bucket of claim 1 further comprising a closure at the liner mouth.

3. The tool bucket of claim 1 further comprising a lip form in the lip.

4. The tool bucket of claim 1 further comprising attachment points between the lip and bottom.

5. The tool bucket of claim 1 further comprising a boot at the bottom.

6. The tool bucket of claim 1 further comprising a foot at the bottom.

7. The tool bucket of claim 4 further comprising a handle attached to the attachment points.

8. The tool bucket of claim 1 wherein the lip is located between one third and one half the distance from the top to the bottom of the sleeve.

9. A tool bucket comprising:
a sleeve having a top, and a bottom;
a lip form attached to the sleeve between the top and the bottom, forming a lip, the portion of the sleeve between the lip and the top defining a liner, the portion of the sleeve between the lip and the bottom defining a bucket, the top of the sleeve defining a liner mouth;
a boot attached to the bucket at the bottom of the sleeve;
a foot attached to the bucket at the bottom of the sleeve to close the bottom of the sleeve;
a plurality of attachment points, in the sleeve between the lip and the bottom;
a handle attached to the attachment points; and
a closure attached to the liner mouth.

10. The tool bucket of claim 9 wherein the plurality of attachment points are rivets penetrating the sleeve.

11. The tool bucket of claim 9 wherein the foot is further comprised of a base sandwiched between a sole and a floor.

12. The tool bucket of claim 9 wherein the boot is comprised of leather.

13. The tool bucket of claim 9 wherein the sleeve material is comprised of canvas.

14. The tool bucket of claim 9 wherein the sole is comprised of leather.

15. The tool bucket of claim 9 wherein the floor is comprised of the same material as the sleeve.

16. The tool bucket of claim 9 wherein the base is comprised of a wood product.

17. The tool bucket of claim 9 wherein the lip form is attached to the sleeve between one third and one half the distance from the top to the bottom of the sleeve.

18. A method for transporting material in a tool bucket, the method comprising:
providing a tool bucket, the tool bucket including a mouth, a liner and a closure, the liner extendable above the mouth of the tool bucket;
extending the liner out of the tool bucket above the mouth of the tool bucket;
placing the material in the bucket;
closing the liner with the closure;
moving the tool bucket from a first location to a second location;
opening the closure; and
removing the material from the tool bucket.

19. The method of claim 18 further comprising folding the liner upon itself to effectively shorten the liner, prior to the closing the liner with the closure.

20. The method of claim 18 wherein closing the liner with the closure constrains material that protrudes out from the liner.
